(19) United States
(12) Patent Application Publication
(10) Pub. No.: US 2009/0251137 A1
(43) Pub. Date: Oct. 8, 2009

(54) Method for determining the layer thickness of an electrically conductive coating on an electrically conductive substrate

(76) Inventors: Gabriel Daalmans, Höchstadt (DE); Sergej Scheiermann, Enger (DE)

Correspondence Address: HARNESS, DICKEY & PIERCE, P.L.C., P.O.BOX 8910, RESTON, VA, 20195, US

(21) Appl. No.: 12/227,527

(22) PCT Filed: May 25, 2007
(86) PCT No.: PCT/EP2007/055074

§ 371 Date: Nov. 20, 2008

(30) Foreign Application Priority Data
May 31, 2006 (DE) 10 2006 025 356.6

(51) Int. Cl. G01B 7/06

(52) U.S. Cl. 324/230

(57) ABSTRACT

An embodiment of the present invention discloses a method for determining the layer thickness of an electrically conductive coating which is applied on an electrically conductive substrate of a test object. First, the induced voltage of an eddy current sensor is collected in the air as a function of the frequency of an exciter field. The majority of coated reference objects which have been provided each contains a substrate and coating from the same materials, such as the substrate and coating of the test object. The reference objects display various known layer thicknesses. A reference voltage can be detected for each reference object as a function of the frequency of the exciter field with the eddy current sensor. Subsequently, a material induced voltage can be determined from the reference voltage and the induced voltage of the eddy current sensor in the air for each reference object. Afterwards, standard amplitude of the material induced voltage can be generated for each reference object. Thus, a calibration curve results, which represents the standard amplitude of the material induced voltage as a function of layer thickness of the coating. The standard amplitude is also determined in the same way for test objects. Thus, the layer thickness of the coating of the test object is determined by the calibration curve.

### PRIORITY STATEMENT

This application is the national phase under 35 U.S.C. § 371 of PCT International Application No. PCT/EP2007/055074 which has an International filing date of May 25, 2007, which designated the United States of America and which claims priority on German application No. 10 2006 025 356.6 filed May 31, 2006, the entire contents of which are hereby incorporated herein by reference.

### FIELD

At least one embodiment of the invention generally relates to a method for determining the layer thickness of an electrically conductive coating, which is applied on an electrically conductive substrate of a test object.

### BACKGROUND

Nondestructive methods are required for numerous material tests. For example, the surfaces of metal parts are often exposed to an environment which causes corrosion, oxidation, diffusion and other ageing processes. This also pertains for example to a blade wheel of a gas turbine, which is exposed to corrosion owing to the mechanical and chemical stresses.

In order to prevent or reduce these corrosion risks, the surfaces of such a substrate are often provided with one or more protective layers. The protective layers are likewise exposed to the external effects, albeit to a lesser extent. Yet internal effects may also initiate ageing processes. Physical and chemical reactions take place in the boundary layers between the substrate and the coating, for example diffusion and oxidation, by which the quality of the coating is affected.

In order to be able to test the current status of such coated substrates regularly, nondestructive test methods are required.

U.S. Pat. No. 6,377,039 B1 discloses a method for determining properties of a coated substrate. The test object is exposed to an alternating electromagnetic field with an adjustable frequency. Eddy currents are thereby induced in the test object. The electromagnetic field generated by the eddy currents, or its induced voltage, is recorded. In particular, the frequency spectrum of the induced voltage is determined. In order to be able to ascertain the layer thickness, the user is provided with the layer thickness as a function of the measurable quantities, so that the layer thickness can be determined indirectly.

This system however requires an extensive data set for each test object, with detailed information about the physical and geometrical properties of the test object. By employing two-dimensional or three-dimensional field calculation and with the use of particularly configured planar eddy current probes, the data set is supplemented with the impedances or voltages induced by the material in the eddy current probe as a function of frequency, layer thickness and electrical and magnetic properties of the layers. The impedances or voltages are represented in the complex plane as so-called grid structures. The grid structures are obtained from two curve families intersecting approximately perpendicularly. A curve is obtained by varying a first parameter with fixed values for all other parameters. The curve family is obtained respectively with a different value of a second parameter. The grid is then obtained by connecting the impedances or voltages for a given value of the first parameter and a variable value of the second parameter.

Since the field calculation is carried out using differential equations, namely the Maxwell equations, the absolute values of the voltage and the impedance are obtained only by a fitting procedure with measurement data. Numerous measurements on test specimens are therefore required beforehand in order to compile the complete data set. Special software and hardware are required for the evaluation. The software and hardware must be adapted to the test object and the quantities to be recorded. The software and hardware are usually supplied by the system provider. For adapted software and hardware, the manufacturer and/or developer of the test object must send information to the system provider in advance. From the point of view of the manufacturer or developer, however, it is undesirable to have to send confidential technical data, particularly in the development phase.

### SUMMARY

At least one embodiment of the invention provides a method for determining the layer thickness of an electrically conductive coating on an electrically conductive substrate, which can be carried out with comparatively little outlay on measurement technology and design.

The method of at least one embodiment comprises the following steps:
a) recording the induced voltage in an eddy current sensor in air as a function of the frequency of an excitation field,
b) providing a multiplicity of coated reference objects, which respectively comprise a substrate and a coating of the same materials as the substrate and the coating of the test object, the reference objects having different known layer thicknesses,
c) recording a reference voltage as a function of the frequency of the excitation field for each reference object using the eddy current sensor,
d) determining a material-induced voltage from the reference voltage and the induced voltage of the eddy current sensor in air as a function of the frequency for each reference object,
e) forming a normalized amplitude of the material-induced voltage as a function of the frequency for each reference object,
f) compiling a calibration curve, which represents the normalized amplitude of the material-induced voltage as a function of the layer thickness of the coating,
g) carrying out steps c) to e) with the test object, and
h) determining the layer thickness of the coating of the test object from the normalized amplitude using the calibration curve.

The essence of at least one embodiment of the invention is that on the one hand by recording the reference voltage in step c) and on the other hand by normalizing the material-induced voltage in step e), those properties which depend for example on the properties of the eddy current sensor or the excitation current are eliminated. This makes it possible to use a simply designed measuring device. It is possible to use eddy current sensors which are constructed from standard commercial components.

Preferably, the material-induced voltage is the difference vector in the complex voltage plane between the vector of the reference voltage and the vector of the induced voltage of the eddy current sensor in air. In particular, effects of the eddy current sensor are thereby eliminated. The amplitude and/or the phase of the complex material-induced voltage may subsequently be determined.

In the example embodiment, at least one uncoated reference object is provided, from which a further reference voltage is recorded as a function of the frequency of the excitation field using the eddy current sensor. It is thereby possible to compensate for effects which are attributable to the substrate.

In particular, a further material-induced voltage of the uncoated reference object is formed from the further reference voltage and the induced voltage of the eddy current sensor in air. The effects of the eddy current sensor are therefore also eliminated for the uncoated reference object.

For example, the material-induced voltage of the uncoated reference object is the difference vector in the complex voltage plane between the vector of the further reference voltage and the vector of the induced voltage of the eddy current sensor in air. The same measurement method is therefore used for the uncoated reference object as for the coated reference objects.

Advantageously, the frequency or frequencies at which a resonance or resonances occur in the eddy current sensor are established in step a). In this way, it is possible to establish the frequencies at which the eddy current sensor behaves linearly and is therefore suitable for the method.

Expediently, the calibration curve is compiled for a frequency at which no resonances occur in the eddy current sensor. This ensures that the eddy current sensor will behave linearly in respect of the relevant quantities.

For example, only eddy current sensors of the same construction are used for the method. The effect of the properties of the eddy current sensor is thereby reduced.

It is however particularly advantageous for the same eddy current sensor always to be used for the method. In this way, the effect of the characteristic quantities of the eddy current sensor is eliminated.

Preferably, the eddy current sensor used comprises a flexible flat piece and at least one coil. Owing to the flexible flat piece, the eddy current surface can be adapted to the structure of the surface of the test object. This ensures that the distance between the coatings and the eddy current sensor is always of the same size.

In one embodiment, the eddy current sensor used comprises at least one coil which is used both as an excitation coil and as a detector coil. This is a particularly simple and cost-effective design.

As an alternative to this, the eddy current sensor used may comprise at least one separate excitation coil and at least one separate detector coil. This reduces the effect of the excitation current on the measurement.

Preferably, the at least one coil in the eddy current sensor being used is designed as a flat conductor track which is applied on the flexible flat piece. The eddy current sensor can thereby be adapted with high accuracy to the structure of the surface of the test object.

For example, the conductor track of the coil in the eddy current sensor being used is designed in the shape of a spiral. A particularly strong magnetic field can thereby be generated.

As an alternative to this, the conductor track of the coil in the eddy current sensor being used may also be designed in the shape of meanders. The connection terminals may in this case be arranged outside the coil, so that there is no perturbing part between the coil and the coating.

Lastly, it is proposed that that the substrate of the reference object should be identical to the substrate of the test object. This reduces the effect of the substrate. At the same time, the effect of the coating on the measurement is thereby increased.

### BRIEF DESCRIPTION OF THE DRAWINGS

The method according to the invention will be explained in more detail below in the description of the figures with the aid of example embodiments and with reference to the appended drawings, in which:

FIG. 1 shows a schematic plan view of a first embodiment of an eddy current sensor for the method according to an embodiment of the invention,

FIG. 2 shows a schematic plan view of a second embodiment of an eddy current sensor for the method according to an embodiment of the invention,

FIG. 3 shows a schematic; plan view of a third embodiment of an eddy current sensor for the method according to an embodiment of the invention,

FIG. 4 shows, a schematic plan view of a fourth embodiment of an eddy current sensor for the method according to an embodiment of the invention,

FIG. 5 shows a diagram of the phase of a complex voltage as a function of the frequency,

FIG. 6 shows a schematic representation of difference vectors in the complex voltage plane,

FIG. 7 shows a diagram of a normalized amplitude of a material-induced voltage as a function of the frequency,

FIG. 8 shows a diagram of a calibration curve, which represents the normalized amplitude of the material-induced voltage as a function of the layer thickness,

FIG. 9 shows the diagram of the calibration curve in FIG. 8, on which a measurement value is marked and the layer thickness is determined graphically therefrom, and

FIG. 10 shows the equivalent circuit diagram and a schematic sectional excerpt of the eddy current sensor and the test object.

### DETAILED DESCRIPTION OF THE EXAMPLE EMBODIMENTS

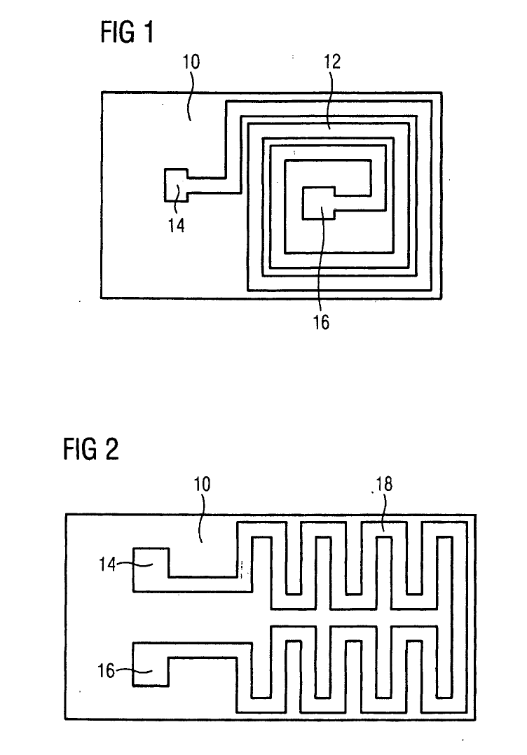

FIG. 1 shows a schematic plan view of a first embodiment of an eddy current sensor, which may be used for the method according to the invention. The eddy current sensor comprises a flexible flat piece 10, on which a coil 12 is applied. The coil 12 is designed as a conductor track in the shape of a spiral. On the flat piece 10, there is a first connection terminal 14 outside the coil 12 at one end of the conductor track. Inside the coil 12, there is a second connection terminal 16 at the other end of the conductor track. The coil 12 is provided as an excitation coil and also as a detector coil.

FIG. 2 represents a schematic plan view of a second embodiment of the eddy current sensor. The second embodiment of the eddy current sensor also comprises a flexible flat piece 10, on which a coil 18 is applied. The coil 18 is designed as a conductor track in the shape of meanders. The first connection terminal 14 and the second connection terminal 16 respectively lie at the two ends of the meandering conductor track of the coil 18. The connection terminals 14 and 16 are separated from the turns of the coil 18. This has the advantage that the eddy current sensor can be arranged on a test object so that the connection terminals 14 and 16 have no contact with the test object. The coil 18 is also provided both as an excitation coil and also as a detector coil.

For the eddy current sensors in FIG. 1 and FIG. 2, the design outlay is small since in each case only one coil is required, which possesses two functions, namely as an excitation coil and as a detector coil.

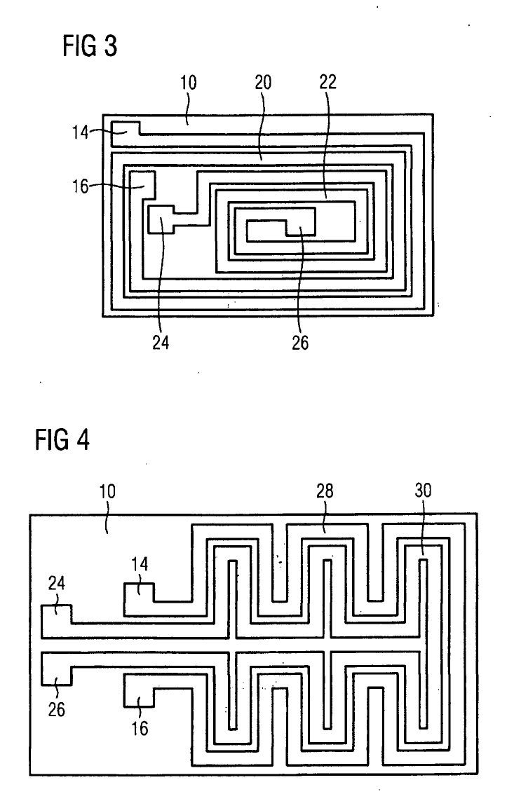

FIG. 3 shows a schematic plan view of a third embodiment of an eddy current sensor for the method according to the invention. The third embodiment of the eddy current sensor likewise comprises a flexible flat piece 10. An excitation coil 20 and a detector coil 22 are applied on the flat piece 10. The excitation coil 20 and the detector coil 22 are designed as spiraling conductor tracks. The detector coil 22 lies inside the excitation coil 20. The first connection terminal 14 and the second connection terminal 16 are located at the two ends of the conductor track of the excitation coil 20. A third connection terminal 24 and a fourth connection terminal 26 are located at the ends of the conductor track of the detector coil 22.

FIG. 4 shows a schematic plan view of a fourth embodiment of the eddy current sensor. The fourth embodiment of the eddy current sensor also comprises a flexible flat piece 10. An excitation coil 28 and a detector coil 30 are applied on the flat piece 10. The excitation coil 28 and the detector coil 30 are designed as meandering conductor tracks. The excitation coil 28 lies inside the detector coil 30. The first connection terminal 14 and the second connection terminal 16 are located at the two ends of the conductor track of the excitation coil 28. The third connection terminal 24 and the fourth connection terminal 26 are located at the ends of the conductor track of the detector coil 30. The connection terminals 14, 16, 24 and 26 are separated from the turns of the coils 28 and 30. The eddy current sensor can therefore be arranged on the test object so that the connection terminals 14, 16, 24 and 26 have no contact with the test object.

All four eddy current sensors represented in FIG. 1 to FIG. 4 are preferably designed as planar coils. The flat piece 10 in all four embodiments is flexible, so that the eddy current sensors can be adapted geometrically to the surface of the test object. The conductor tracks of the coils 12, 18, 20, 22, 28 and 30 are preferably made of copper. The flat piece 10 is for example made of Kapton film.

In a first step of the method according to an embodiment of the invention, an eddy current sensor is selected which is suitable for a test object. The voltage U(air, ω) across the coil 12 or 18, or across the detector coil 22 or 30, is subsequently measured as a function of the frequency ω when the eddy current sensor is in air. Those frequencies at which resonances occur are thereby determined.

These frequencies will not be used during the subsequent analysis, since the eddy current sensor does not behave linearly at these frequencies.

FIG. 5 shows a diagram in which the phase of the recorded complex voltage is represented as a function of the frequency. The function value corresponds to the tangent value of the phase. A first characteristic curve 32 relates to a measurement during which the eddy current sensor is in air. A second characteristic curve 34 relates to a measurement during which the eddy current sensor is arranged on a special alloy. A third characteristic curve 36 represents a measurement during which the eddy current sensor lies on an aluminum specimen. In this example, resonances occur at two positions. The frequency range between 4 MHz and 6 MHz, however, is free from resonances so that this frequency range is particularly suitable.

Next, a plurality of reference objects are provided, which comprise a substrate that is identical to the substrate of the test object. The reference objects respectively comprise a coating with different layer thicknesses. The layer thicknesses may for example be measured optically, and are therefore known. At least one reference object is uncoated. The coating of the reference objects is made of the same material as the coating of the test object. From each reference object, a reference voltage U(x,ω) as a function of the frequency is recorded using the eddy current sensor. The difference vector in the complex voltage plane is determined between the reference voltage U(x,ω) and that voltage U(air, ω) when the eddy current sensor is in air. This difference vector corresponds to a complex material-induced voltage Uₘₐₜ(x). The amplitude |Uₘₐₜ(x)| and the phase φₘₐₜ of this material-induced voltage Uₘₐₜ(x) are ascertained.

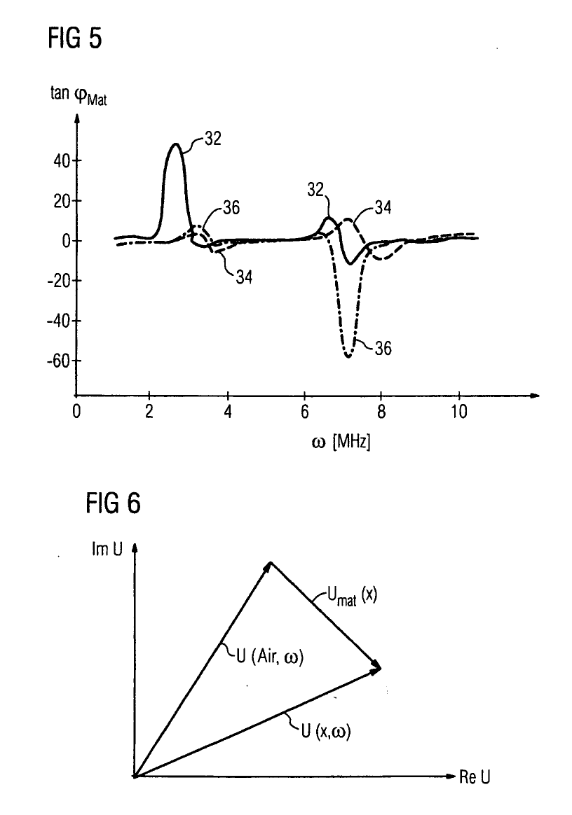

FIG. 6 represents a schematic representation of the relevant voltage vectors in the complex voltage plane. The two Cartesian coordinates correspond to the real part and the imaginary part of the voltage, respectively. A vector U(air, ω) corresponds to the voltage when the eddy current sensor is in air. The reference voltage U(x,ω) is likewise represented as a vector. The difference vector of the two said vectors corresponds to the material-induced voltage Uₘₐₜ(x).

A reference voltage U(b,ω) of the uncoated reference object is likewise measured, a difference vector Uₘₐₜ(b) is formed and the amplitude |Uₘₐₜ(b)| thereof is determined.

In a next step, the normalized amplitude for the material-induced voltage is formed. To this end the amplitude |Uₘₐₜ(x)| is normalized with respect to the amplitude |Uₘₐₜ(b)|. Frequency dependencies of the material-induced voltage, which depend on the properties of the coils, are thereby eliminated.

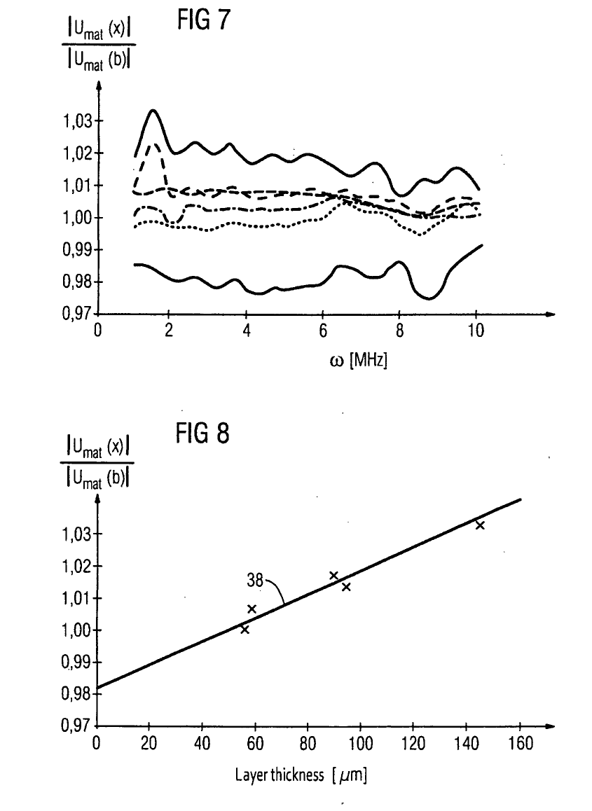

FIG. 7 shows the normalized amplitude |Uₘₐₜ(x)|/|Uₘₐₜ(b)| for the material-induced voltage as a function of the frequency. Each characteristic curve corresponds to a particular layer thickness of the coating of the reference object. The lowermost characteristic curve corresponds to the uncoated reference object.

In a further step, one or more calibration curves are compiled. The calibration curves represent the normalized amplitudes for the material-induced voltage as a function of the layer thickness. The calibration curves are determined from the characteristic curve set according to FIG. 7. To this end a particular frequency is selected, which lies outside the resonance range. The function values at this frequency are assigned to the known layer thicknesses.

FIG. 8 represents an example of the calibration curve. This calibration curve is obtained from FIG. 7 when the function values for 4 MHz are used. FIG. 8 illustrates that there is a linear relationship between the normalized amplitude and the layer thickness.

During the actual measurement, a test object with an unknown layer thickness is examined. In the test object, both the substrate 50 and the coating are made of the same materials as in the reference objects. The measurement is carried out in a similar way to the measurements of the reference objects.

First the complex voltage is measured using the same eddy current sensor, and then the difference vector is determined.

The difference vector corresponds to the material-induced voltage. The amplitude of this is formed and normalized with respect to the amplitude |Uₘₐₜ(b)| of the uncoated reference object. From the normalized amplitude, the layer thickness of the coating 52 of the test object can be ascertained using the calibration curve.

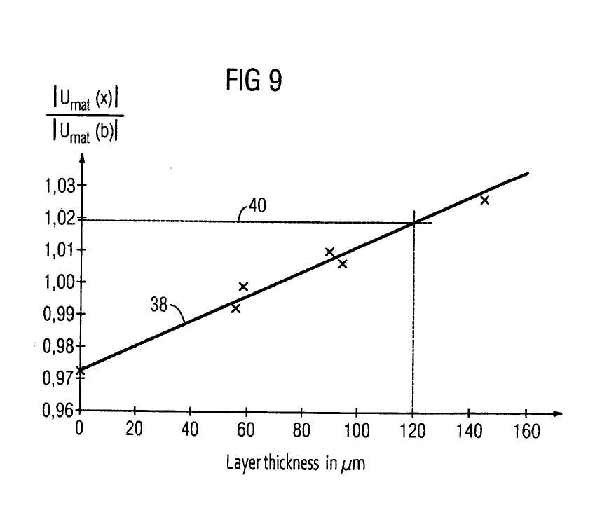

FIG. 9 shows the calibration curve according to FIG. 8, which additionally comprises an ascertained numerical value 40 of the normalized amplitude for the test object 50. The test object 50 comprises a coating 52 with an unknown layer thickness. In this example, the numerical value 40 for the normalized amplitude is about 1.017. Using the calibration curve, the layer thickness of the coating 52 can be determined graphically therefrom. In this specific example, the layer thickness is 123 μm. The calibration curve and the underlying measurement values may be stored in an EDP system, so that the layer thickness can be calculated and output by means of a suitable EDP program after the amplitude has been input.

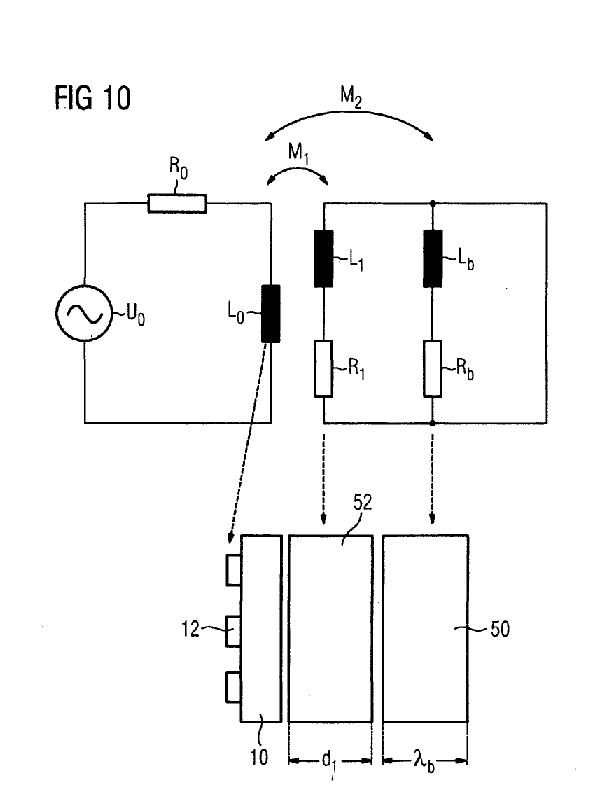

FIG. 10 represents the equivalent circuit diagram and a schematic sectional excerpt of the eddy current sensor and the test object. The equivalent circuit diagram comprises an inductance L₀, an alternating current source U₀ and a resistance R₀, which are connected in series and form an excitation circuit. The electrically conductive coating 52 can be represented by a resistance R₁ and an inductance L₁, which are connected in series. The substrate 50 can be represented by a resistance R_{b} and an inductance L_{b}, which are connected in series.

With neglect of the capacitances, the material-induced voltage is given by:

Uₘₐₜ(x)=jωM₁I₁+jωM₂I₂, (1)

where M₁ is the mutual inductance in the coating 52, M₂ is the mutual inductance in the coated substrate 50, I₁ is the current in the coating 52 and 12 is the current in the substrate 50.

The material-induced voltage can also be expressed using the excitation current I_{exc}:

$${U}_{mat} ( x ) = {{I}_{exc} ( {M}_{1} ω )}^{2} / ( jω {L}_{1} + {R}_{1} ) + {{I}_{exc} ( {M}_{2} ω )}^{2} / ( jω {L}_{b} + {R}_{b} ) . \qquad ( 1 a )$$

For metallic materials, the following applies in the frequency range of a few megahertz:

ωL<<R, (2)

so that the expression for the material-induced voltage is simplified:

Uₘₐₜ(x)=I_{exc}(ω²M₁²/R₁+ω²M₂²/R_{b}). (1b)

For the substrate 50 without a coating 52:

Uₘₐₜ(b)=I_{exc}ω²M₃²/R_{b}, (3)

where M₃ is the mutual inductance in the uncoated substrate 50. Since the uncoated substrate 50 consists of the same material as the coated substrate 50, the material-dependent quantities L_{b} and R_{b} may also be used. The mutual inductance M₃ of the uncoated substrate 50 differs from the mutual inductance M₂ of the coated substrate 50 owing to the different distances between the substrate 50 and the eddy current sensor. If the materials of the substrate 50 and the coating 50 have similar electrical properties, then the mutual inductances M₁ and M₃ differ only slightly.

From Equation (1b) and Equation (3), the following is obtained for the normalized material-induced voltage:

Uₘₐₜ(x)/Uₘₐₜ(b)=(M₁²/M₃²)(R_{b}/R₁)+M₂²/M₃² (4)

The mutual inductances M₁, M₂ and M₃ depend on the distance between the eddy current circuit and the eddy current sensor. The ratios between the mutual inductances in Equation (4) are therefore not equal to one. Furthermore, the mutual inductances depend on the technical data of the coils, so that the calibration curve and the actual measurement must be carried out using the same eddy current sensor.

For the resistance values:

R₁=bρ₁/(wd₁), (5)

R₂=bρ_{b}/(wλ_{b}), (6)

where ρ₁ is the resistivity of the coating 52, ρ_{b} is the resistivity of the substrate 50, b is the length of the conductor track, w is the width of the coil, d₁ is the desired layer thickness of the coating 52 and λ_{b} is the penetration depth of the magnetic field into the substrate 50. The following is therefore obtained for the normalized voltage amplitude:

Uₘₐₜ(x)/Uₘₐₜ(b)=(M₁²/M₃²)(ρ_{b}d₁/ρ₁λ_{b})+M₂²/M₃² (7)

Equation (7) illustrates that to a first approximation, the normalized voltage amplitude is proportional to the layer thickness d₁. The calibration curve is therefore also linear for a particular material.

The method according to an embodiment of the invention is a particularly simple and fast method. The design outlay for carrying out the method according to an embodiment of the invention is negligibly small.

Prototypes of modified substrates 50 and/or coatings can be tested within a short time. It is not necessary for internal company information to be sent beforehand to external companies so that special software and/or hardware can be provided. The manufacturer or developer of the test object is therefore capable of carrying out the method according to an embodiment of the invention inside the company, so that no confidential information has to be given to external companies.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for determining the layer thickness of an electrically conductive coating, which is applied on an electrically conductive substrate of a test object, the method comprising:
recording an induced voltage in an eddy current sensor in air as a function of the frequency of an excitation field;
providing a multiplicity of coated reference objects, which respectively include a substrate and a coating of the same materials as the substrate and the coating of the test object, the reference objects having different known layer thicknesses;
recording a reference voltage as a function of a frequency of the excitation field for each reference object using the eddy current sensor;
determining a material-induced voltage from the reference voltage and the induced voltage of the eddy current sensor in air as a function of the frequency for each reference object;
forming a normalized amplitude of the material-induced voltage as a function of the frequency for each reference object;
compiling a calibration curve, which represents the normalized amplitude of the material-induced voltage as a function of the layer thickness of the coating;
carrying out the recording the reference voltage, determining and forming of the normalized amplitude with the test object; and
determining the layer thickness of the coating of the test object from the determined normalized amplitude using the compiled calibration curve.

2. The method as claimed in claim 1, wherein the material-induced voltage is the difference vector in the complex voltage plane between the vector of the reference voltage and the vector of the induced voltage of the eddy current sensor in air.

3. The method as claimed in claim 1, wherein at least one of the amplitude and the phase of the complex material-induced voltage are determined.

4. The method as claimed in claim 1, wherein at least one uncoated reference object is provided, from which a further reference voltage is recorded as a function of the frequency of the excitation field using the eddy current sensor.

5. The method as claimed in claim 4, wherein a further material-induced voltage of the uncoated reference object is formed from the further reference voltage and the induced voltage of the eddy current sensor in air.

6. The method as claimed in claim 5, wherein the material-induced voltage of the uncoated reference object is a difference vector in the complex voltage plane between the vector of the further reference voltage and the vector of the induced voltage of the eddy current sensor in air.

7. The method as claimed in claim 1, wherein the at least one frequency at which at least one resonance occurs in the eddy current sensor is established in the recording of the induced voltage.

8. The method as claimed in claim 7, wherein the calibration curve is compiled for a frequency at which no resonances occur in the eddy current sensor.

9. The method as claimed in claim 1, wherein only eddy current sensors of the same construction are used for the method.

10. The method as claimed in claim 1, wherein the same eddy current sensor is always used for the method.

11. The method as claimed in claim 1, wherein the eddy current sensor used comprises a flexible flat piece and at least one coil.

12. The method as claimed in claim 1, wherein the eddy current sensor used comprises at least one coil, which is used both as an excitation coil and as a detector coil.

13. The method as claimed in claim 1, wherein the eddy current sensor used comprises at least one separate excitation coil and at least one separate detector coil.

14. The method as claimed in claim 1, wherein, in the eddy current sensor being used, the at least one coil is designed as a flat conductor track, which is applied on the flexible flat piece.

15. The method as claimed in claim 14, wherein, in the eddy current sensor being used, the conductor track of the coil is designed in the shape of a spiral.

16. The method as claimed in claim 14, wherein, in the eddy current sensor being used, the conductor track of the coil is designed in the shape of meanders.

17. The method as claimed in claim 1, wherein the substrate of the reference object is identical to the substrate of the test object.

18. The method as claimed in claim 2, wherein at least one of the amplitude and the phase of the complex material-induced voltage are determined.

19. The method as claimed in claim 2, wherein at least one uncoated reference object is provided, from which a further reference voltage is recorded as a function of the frequency of the excitation field using the eddy current sensor.

20. The method as claimed in claim 2, wherein the at least one frequency at which at least one resonance occurs in the eddy current sensor is established in the recording of the induced voltage.
